(19) United States
(12) Patent Application Publication
(10) Pub. No.: US 2010/0150049 A1
(43) Pub. Date: Jun. 17, 2010

(54) BEARER CONTROL AND MANAGEMENT METHOD IN THE IP-BASED EVOLVED MOBILE COMMUNICATION NETWORK

(75) Inventors: Chang-ki Kim, Daejeon-si (KR); Han-Jun Yoon, Daejeon-si (KR); Young-Jick Bahg, Daejeon-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Institute, Daejeon-si (KR)

(21) Appl. No.: 12/526,628

(22) PCT Filed: May 22, 2008
(86) PCT No.: PCT/KR08/02853

§ 371 Date: Aug. 10, 2009

(30) Foreign Application Priority Data
Dec. 14, 2007 (KR) 10-2007-0131018

(51) Int. Cl. H04W 72/04; H04H 20/71; H04W 36/00

(52) U.S. Cl. 370/312; 370/338; 370/331

(57) ABSTRACT

A method for controlling and managing a bearer in a gateway of an IP-based mobile communication network is provided. A protocol message that must be sent between a mobility management entity and a gateway where a bearer exists is newly defined as context setup and IP allocation request/response messages, request/response messages for setup and release of a tunnel for service initiation and release, user equipment handover completion/completion acknowledgement messages, paging indication/response messages for a packet coming from a network, and multicast-service join/leave indication messages when the user equipment is powered on/off, resulting in high efficiency of signal protocol and efficient bearer management irrespective of separation or integration of physical nodes of the mobility management entity and the serving gateway.

### TECHNICAL FIELD

The present invention relates to an IP-based evolved mobile communication network, and more particularly, to a method for controlling and managing a bearer between a mobility management entity and a gateway including a bearer.

This work was supported by the IT R&D program of Ministry of Information and Communication (MIC)/Institute for Information Technology Advancement (IITA) [2005-S-404-23, Research and developement on 3G long-term evoluation access system].

### BACKGROUND ART

A current WCDMA mobile communication network was commercially implemented according to a 3rd Generation Partnership Project (3GPP) R6-based standard. As a result, a current WCDMA access network consists of user equipment (UE), a base station (NodeB), a radio network controller (RNC), and a Serving GPRS Support Node (SGSN) and a Gateway GPRS Support Node (GGSN) that are core networks. A protocol and a procedure for a control message and user data transmission among the entities are defined in an R6-related standard. In the 3rd Generation Partnership Project (3GPP), mobile communication network access and a core network are being standardized to realize high transmission rate and short latency and allow access to various IP access networks for a next-generation mobile communication network.

An IP-based evolved UMTS network includes user equipment (UE), an Evolved Universal Terrestrial Radio Access Network (E-UTRAN), and an Evolved Packet Core (EPC) for high transmission rate and short latency in place of many physical functional entities of a conventional access network. The EPC is used to provide comparability such as handoff with an existing network R6 and mobility with an IP-based WLAN network [T523.401].

For reference, the E-UTRAN includes a plurality of base stations (eNodeBs). The EPC includes a Mobility Management Entity (hereinafter, referred to as MME) for controlling and managing terminal mobility and a bearer, a Serving Gateway (SGW) for transmitting and receiving the bearer through GTP tunnel allocation and release, and a Packet Data Network Gateway (PDN GW) for allocating a terminal IP address. The functional entities of the IP-based evolved UMTS network and the functional entities of the existing network have the following relationship.

The eNodeB of the E-UTRAN includes many functions of the RNC in existing R6, and particularly, a radio resource control (RRC) function corresponding to medium access control (MAC), radio link control (RLC), and layer L3 control that are functions of layer L2 of the RNC; and a Packet Data Compression Protocol (PDCP) function corresponding to a user packet compression function of the RNC in the R6. The EPC includes the functions of the SGSN and the GGSN of the R6, as well as some functions of the RNC of the R6.

For standardization of 3G Long Term Evolution (LTE), service-based requirements have been accepted, logically functional entities have been defined according to the requirements, and a call processing flow and a protocol between the functional entities have been standardized. With respect to the present invention, an interface between the eNodeB and the EPC (eNodeB-MME (S1-MME): S1-AP and eNodeB-Serving GW (S1-U): GTP-U) has been standardized and, for an interface S11 between the MME and the SGW and an interface S5 between SGW and PDN GW, a rough inter-entity call flow based on functions of respective entities has been prepared. A detailed protocol is not yet standardized.

### DISCLOSURE OF INVENTION

### Technical Problem

The present invention is directed to a method for controlling and managing a bearer in user equipment according to various variations (e.g., power on/off, service initiation/termination, handover, and paging variations) related to user equipment in an IP-based evolved mobile communication network; and a detailed protocol for an S11 interface between a Mobility Management Entity (MME) in an Evolved Packet Core (EPC) for controlling the bearer and a gateway where a bearer exists actually.

That is, the present invention is directed to efficiently controlling and managing a bearer by designing an optimal protocol using a protocol message including a minimal number of information elements for bearer control.

### Technical Solution

According to an aspect of the present invention, there is provided a method in a gateway of an IP-based mobile communication network, including: receiving a user equipment (UE) context setup request message including a UE ID; creating a UE context table including bearer information using the UE ID as a key, and creating basic information required for creating an IP address to be used by the UE; sending a UE context setup response message including the basic information to the mobility management entity; receiving a UE context release request message including the UE ID from the entity; and deleting a context table and an IP address pool associated with the received UE ID, and sending a UE context release request response message including the result information to the entity.

The method may further include: when a tunnel release request message including the UE ID is received from the mobility management entity, releasing a tunnel associated with the received UE ID, deleting a packet filtering table of the tunnel, and sending a tunnel release response message including the result information to the mobility management entity.

The method may further include: when a handover completion message including the UE ID is received from the mobility management entity, changing eNodeB address information of all tunnels allocated to the received UE ID into new eNodeB address information included in the handover completion message; and sending a handover completion acknowledgement message including the received UE ID and the result information to the mobility management entity.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### Advantageous Effects

According to the present invention, an optimal signal protocol between an MME, which is an S11 interface of a 3G LTE standard reference model, and a gateway where a bearer exists (when a serving gateway as an S5 interface and a packet data network gateway are formed as a single physical node) is designed to include default bearer setup, dedicated bearer setup, intra MME/inter eNodeB handoff, and paging signaling procedures for efficient bearer control and management in an IP-based evolved mobile communication network, resulting in a reduced signaling time and satisfactory system performance requested by the 3G LTE.

According to the present invention, a protocol is designed into UE context and IP setup/release request, tunnel setup/release request, handover completion/completion acknowledgement, paging indication/response, and multicast-service join/leave indication messages according to a bearer control and management function between the MME and the gateway where a bearer exists, so that use of the messages and information elements thereof for control of various bearers can lead to high efficiency of signal protocol.

A UE ID that is an MME context ID in bearer control and management protocol information elements is shared with the gateway where the bearer exists. This allows efficient management of, for example, handoff and tunnel deletion (detachment of use equipment) when several tunnels are set in one user equipment, resulting in optimal bearer control.

Furthermore, the UE ID (i.e., MME Context ID) managed by the MME as a key value for creating a UE context table, which is required for bearer control, is shared. This can facilitate management of the UE context table and reduce a table searching error.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates the structure of an IP-based evolved UMTS network according to an exemplary embodiment of the present invention;

FIG. 2 illustrates a logical internal structure and an external interface structure of an Evolved Packet Core (EPC) in FIG. 1

FIG. 3 illustrates protocol messages for context setup/release and IP address assignment according to an exemplary embodiment of the present invention.

FIG. 4 illustrates a protocol message for tunnel allocation/release according to an exemplary embodiment of the present invention;

FIG. 5 illustrates protocol messages for handover completion/completion acknowledgement, paging indication/response, and multicast-service join/leave indication according to an exemplary embodiment of the present invention;

FIG. 6 is a detailed flowchart illustrating a default-bearer setup process of a terminal attachment procedure using a bearer control and management protocol according to an exemplary embodiment of the present invention;

FIG. 7 illustrates the structure of a UE context table using a UE ID as a key according to an exemplary embodiment of the present invention; and

FIGS. 8, 9 and 10 are flowcharts illustrating a UE context management and IP allocation module in a serving GW according to a bearer management procedure using a bearer management protocol according to an exemplary embodiment of the present invention.

### MODE FOR THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

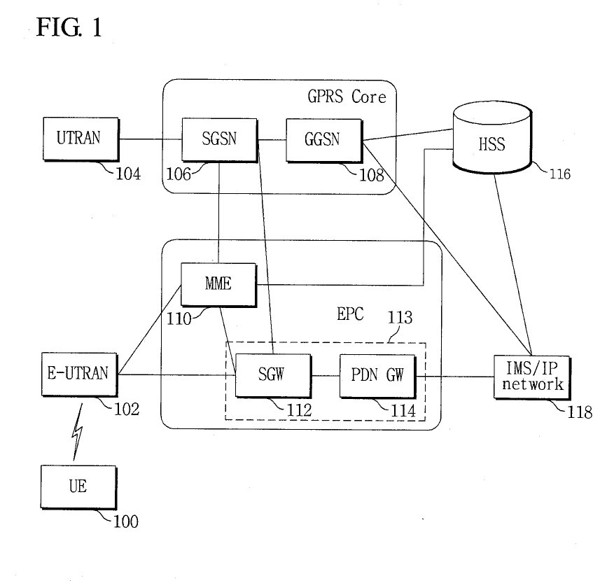

FIG. 1 illustrates the structure of an IP-based evolved UMTS network according to an exemplary embodiment of the present invention.

Referring to FIG. 1, user equipment (UE) 100 is a terminal capable of providing IP multimedia service including voice, video, positioning, and instant message services while satisfying performance requirements for a 3G evolved system. An evolved Universal Terrestrial Radio Access Network (E-UTRAN) 102 includes an eNodeB for providing a connection of the UE 100 via a radio section while satisfying performance requirements for the 3G evolved system, and is connected to a Mobility Management Entity (MME) 110 and a Serving Gateway (SGW) 112 of an S/PDN GW 113 in an Evolved Packet Core (EPC), which is a new functional entity of the 3G evolved system. The MME 110 of the EPC is connected to the eNodeB of the E-UTRAN 102 and connected to the SGW 112 and a home subscriber server (HSS) 116 for subscriber s mobility and bearer management. The SGW 112 allocates a tunnel for user data transmission and is connected to the eNodeB of the E-UTRAN 102 via the tunnel and the Internet (IMS/IP network) 118 via the PDN GW 114.

Meanwhile, the R6-based radio access network, UTRAN 104, includes a Node-B for providing a connection of the UE via an R6 radio section, and a radio network controller (RNC). A Serving GPRS Support Node (SGSN) 106 builds a packet exchange data network with a Gateway GPRS Support Node (GGSN) 108. The SGSN 106 delivers traffic data between the UTRAN 104 and a foreign network or an IP multimedia subsystem (IMS) 118, and is connected to the HSS 116 for subscriber attachment, authentication, and authorization. The SGSN 106 is also connected to the MME 110 and the SGW 112 of the EPC for mobility with the 3G Evolved network.

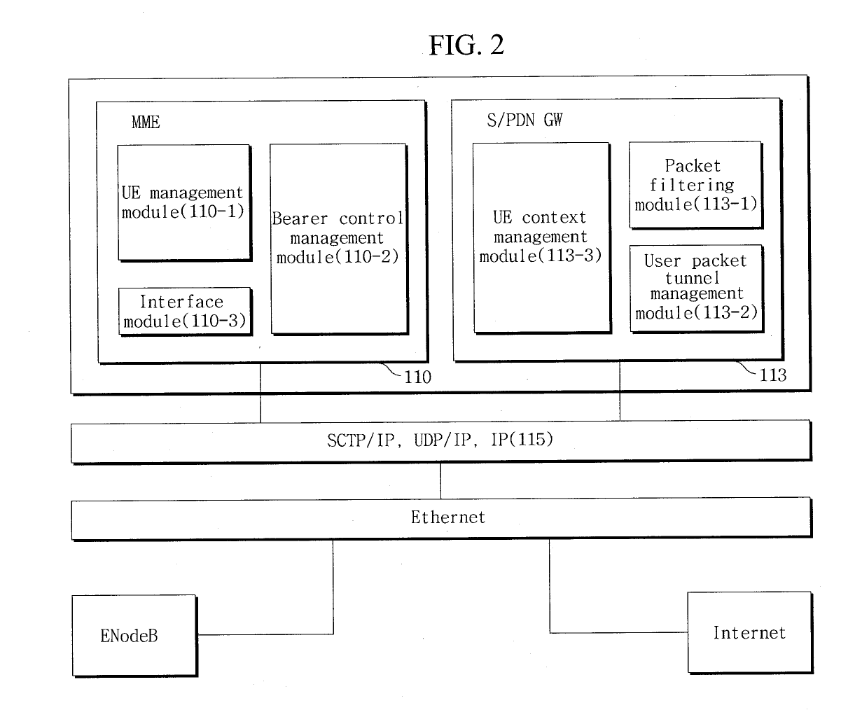

FIG. 2 illustrates a logical internal structure and an external interface structure of the EPC in FIG. 1, in which the EPC is functionally divided into an MME 110 having a control function and an S/PDN GW 113 for processing user data. Separation of physical nodes of the functional entities MME, SGW, and PDN GW remains an issue to be resolved, but it is assumed that the SGW 112 and the PDN GW 114 are configured as a single physical node, i.e., the S/PDN GW 113, and the S/PDN GW 113 and the MME 110 are physically separate entities, as described above.

Referring to FIG. 2, first, the MME 110 includes a UE management module 110-1 for managing UE mobility and a session, a bearer control management module 110-2 for controlling and managing a bearer for user data transmission through communication with the SGW 112, and an interface module 110-3 for transmitting and receiving a control message to and from the eNodeB.

Meanwhile, the S/PDN GW 113 includes a packet filtering module 113-1 for extracting only a packet directed to UE at eNodeB, which is currently managed by the PDN GW 114, from user data coming from a foreign Internet; a user packet transceiver module 113-2 for transmitting a user packet to the eNodeB via a logical path called a tunnel; and a UE context management module 113-3 for managing a UE context and allocating an IP.

A control protocol, S1-AP, between the MME 110 and the eNodeB is via the SCTP/IP 115, a traffic protocol, GTP-U, between the SGW 112 and the eNodeB is via the UDP/IP 115, and a communication between the S/PDN GW 113 and the Internet is made via an IP. The present invention is directed to a bearer management protocol using UDP/IP between the MME 110 and the S/PDN GW 113, and bearer control and management using the bearer management protocol.

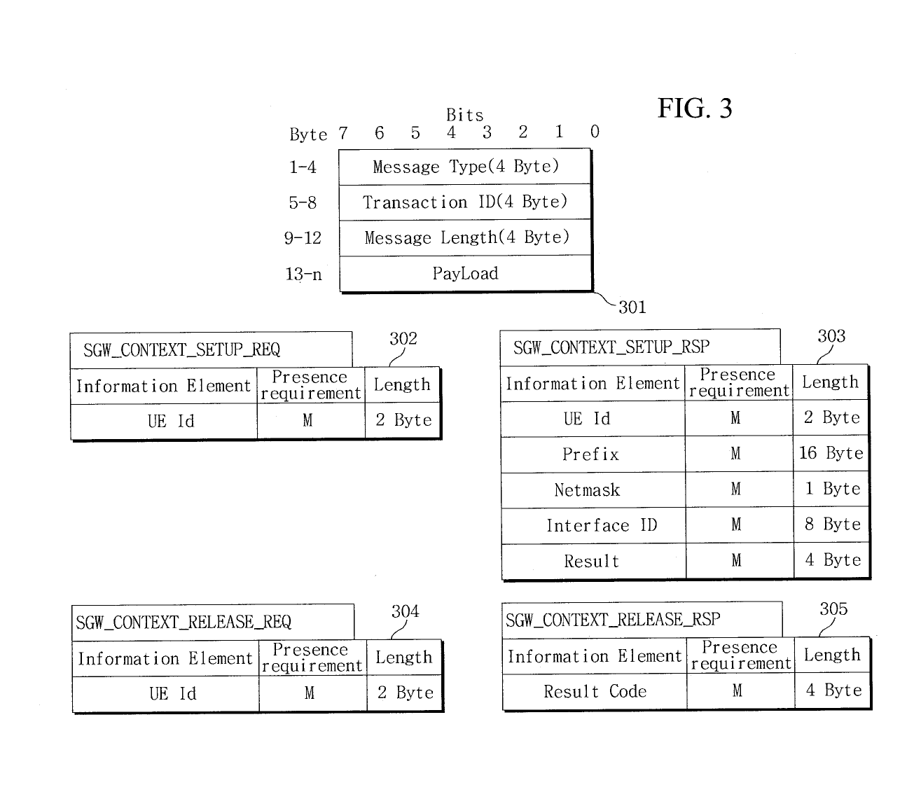

FIG. 3 illustrates protocol messages for context setup/release and IP address assignment according to an exemplary embodiment of the present invention.

A header 301 commonly included in all protocol messages for bearer control and management according to an exemplary embodiment of the present invention consists of a message type for the bearer control, a transaction ID for identifying a message of the same type, a protocol message length, and a payload that depends on the message type. In the common header 301, the message type consisting of first 4 bytes indicates a unique protocol message identifier corresponding to a different function shown in FIGS. 3 to 5.

Referring to FIG. 3, first, messages for UE context setup between the MME 110 and the SGW 112 and UE IP allocation are SGW_CONTEXT_SETUP_REQ 302 and SGW_CONTEXT_SETUP_RSP 303. SGW_CONTEXT_SETUP_REQ 302 corresponding to a UE context setup request message includes, as an information element, a UE ID that is used as a context ID by the MME 110, and SGW_CONTEXT_SETUP_RSP 303 corresponding to a UE context setup response message includes, as information elements, a UE ID, a prefix required for IP allocation, a Netmask, an interface ID, and a result of a UE context setup and IP allocation.

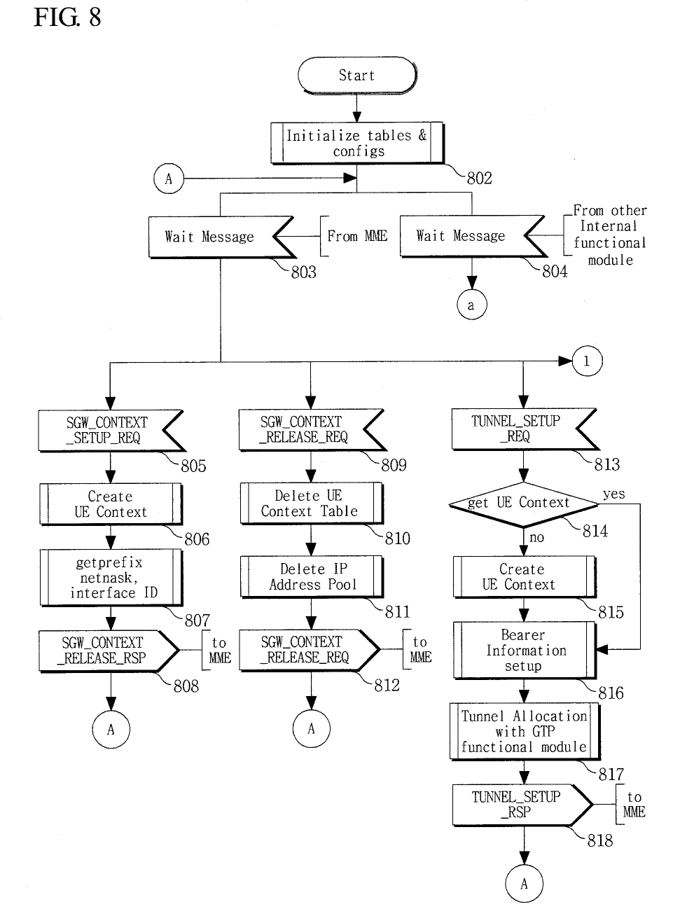

Meanwhile, UE context release request messages for releasing the set UE context are SGW_CONTEXT_RELEASE_REQ 304 and SGW_CONTEXT_RELEASE_RSP 305. SGW_CONTEXT_RELEASE_REQ 304 includes a UE ID of UE to be released as an information element, and SGW_CONTEXT_RELEASE_RSP 305 includes a result code. In FIG. 3, the request message is directed from the MME 110 to the S/PDN GW 113, and the response message is directed from the S/PDN GW 113 to the MME 110. A detailed procedure in the S/PDN GW 113 using each protocol message will be described in more detail with reference to FIG. 8.

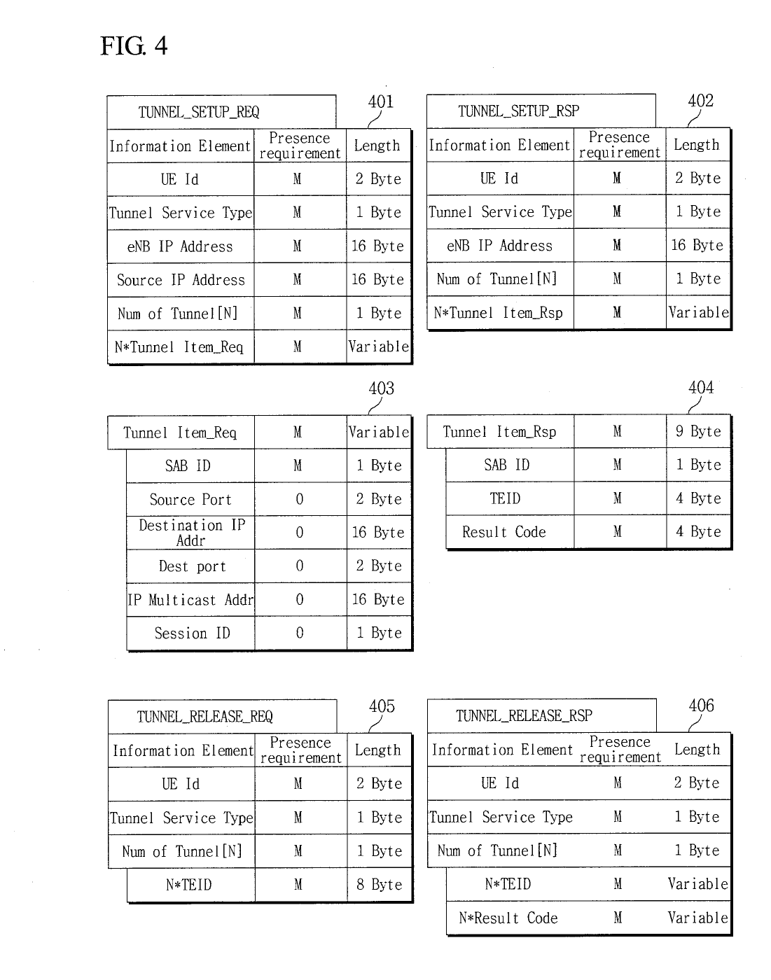

FIG. 4 illustrates a protocol message for tunnel allocation/release according to an exemplary embodiment of the present invention.

Referring to FIG. 4, a tunnel setup request message and a tunnel setup response message for tunnel allocation are TUNNEL_SETUP_REQ 401 and TUNNEL_SETUP_RSP 402. The tunnel setup request messages 401 and 403 include, as information elements, a UE ID, a tunnel service type indicating whether the tunnel is of a unicast type or a multicast type, a correspondent eNodeB IP address of the tunnel, an SAB ID for identifying an SAE bearer, a port/IP address for dedicated bearer Addr, and a multicast address and a session ID for Multimedia-Broadcast Multimedia-Service (MBMS) service that must be provided to the UE for the MBMS service. The tunnel allocation response message 402 includes, as information elements, allocated tunnel endpoint ID (TEID) information, in addition to the basic elements of the tunnel allocation request message (see 404).

Meanwhile, messages for releasing the allocated tunnel include a tunnel allocation release request message TUNNEL_RELEASE_REQ 405 and a corresponding response message TUNNEL_RELEASE_RSP 406. The tunnel allocation release request message 405 includes, as information elements, a tunnel to be released and a UE ID allocated the tunnel, and the response message 406 includes a release result, in addition to the basic information. In FIG. 4, the request message is directed from the MME 110 to the S/PDN GW 113, and the response message is directed from the S/PDN GW 113 to the MME 110. A detailed procedure in the S/PDN GW 113 using each protocol message will be further described with reference to FIG. 8.

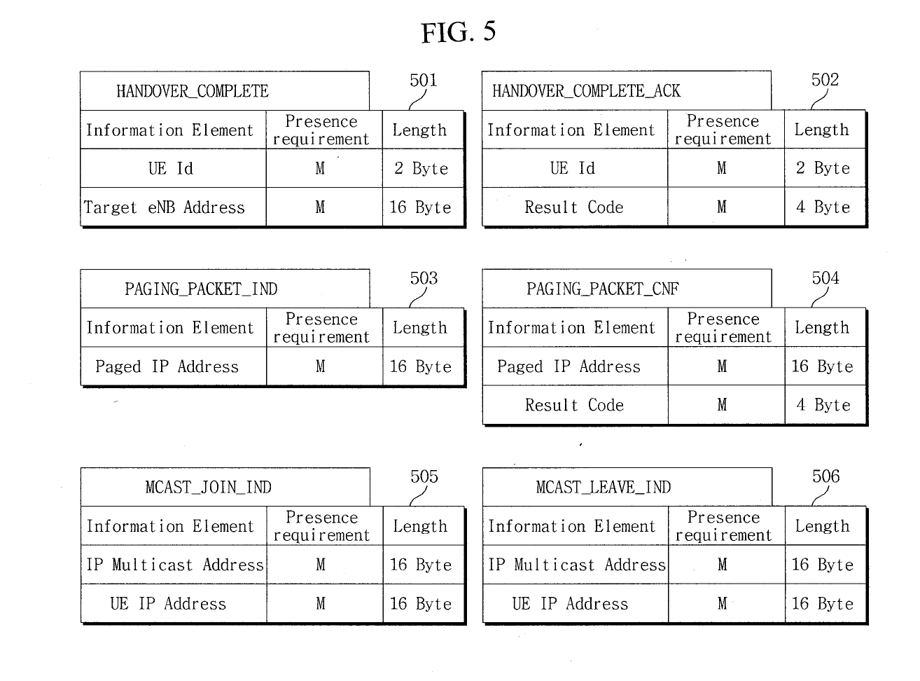

FIG. 5 illustrates protocol messages for handover completion/completion acknowledgement, paging indication/response, and multicast-service join/leave indication according to an exemplary embodiment of the present invention.

First, an eNodeB path of a tunnel must be altered upon intra-MME/inter-eNodeB handover. Messages for changing eNodeB addresses of all tunnels set in the UE, including a new eNodeB address after handover completion are HANDOVER_COMPLETE 501 and HANDOVER_COMPLETE_ACK 502. The handover completion message 501 includes, as information elements, a UE ID of UE after handover and a target eNodeB address to which the UE has moved, and the handover completion acknowledgement message 502 includes the result information as an information element.

Paging indication/response messages, PAGING_PACKET_IND 503 and PAGING_PACKET_CNF 504, are messages indicating call termination directed to the UE in the MME 110 and the S/PDN GW 113. The paging indication message 503 includes a desired paged IP address as an information element, and the paging response message 504 includes the result. In view of the functionality of the paging messages, the paging indication message 503 is directed from the S/PDN GW 113 to the MME 110, and the paging response message 505 is directed from the MME 110 to the S/PDN GW 113.

Multicast-service join/leave indication messages, MCAST_JOIN_IND 505 and MCAST_LEAVE_IND 506, are used for the S/PDN GW 113 to notify the MME 112 of the UE joining/leaving the multicast service. Each of MCAST_JOIN_IND 505 and MCAST_LEAVE_IND 506 includes, as information elements, an UE IP address and an IP multicast address of the multicast service that the UE joins and leaves. A detailed procedure in the SGW 112 using each protocol message will be described in more detail with reference to FIG. 8.

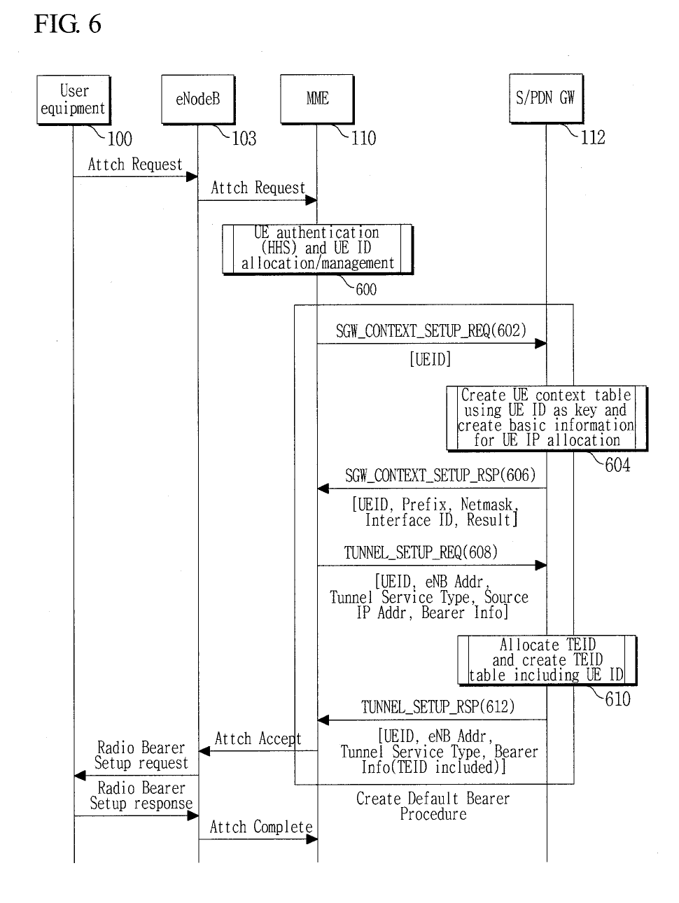

FIG. 6 is a detailed flowchart illustrating a default-bearer setup process of a terminal attachment procedure using a bearer control and management protocol according to an exemplary embodiment of the present invention.

Referring to FIG. 6, first, an attach request originating from the UE 100 arrives at the MME 110 via the eNodeB 103. Although not directly related to the present invention, the MME 110 completes terminal authentication via the HSS 116, and allocates a context ID, i.e., a UE ID (operation 600). After allocating the UE ID, the MME 110 performs a default-bearer creating procedure in cooperation with the S/PDN GW 113.

The default bearer creating procedure will now be described. First, the MME 110 sends a UE context setup request message SGW_CONTEXT_SETUP_REQ including the information elements as shown in FIG. 3 to the S/PDN GW 113 (operation 602). In the S/PDN GW 113, the UE context management module 113-3 creates a UE context table using the received UE ID as a key, creates basic information (e.g., prefix, Netmask, and interface ID) for UE IP allocation (operation 604), and sends a UE context setup response message SGW_CONTEXT_SETUP_RSP including the produced information to the MME 110 (operation 606). Upon receipt of the UE context setup response message, the MME 110 sends a tunnel setup request message TUNNEL_SETUP_REQ including the information elements as shown in FIG. 4 to the S/PDN GW 113 (operation 608). The S/PDN GW 112 then allocates a TEID and creates a TEID table including a UE ID (operation 610), and sends a tunnel setup response message TUNNEL_SETUP_RSP to the MME 110 (operation 612).

Through the default bearer setup process described above, the MME 110 obtains the UE information and the TEID allocated to the bearer from the S/PDN GW 113, and the S/PDN GW 113 creates the UE context table using the UE ID received from the MME 110 as a key, and creates the TEID table using the TEID allocated in the tunnel setup process as a key.

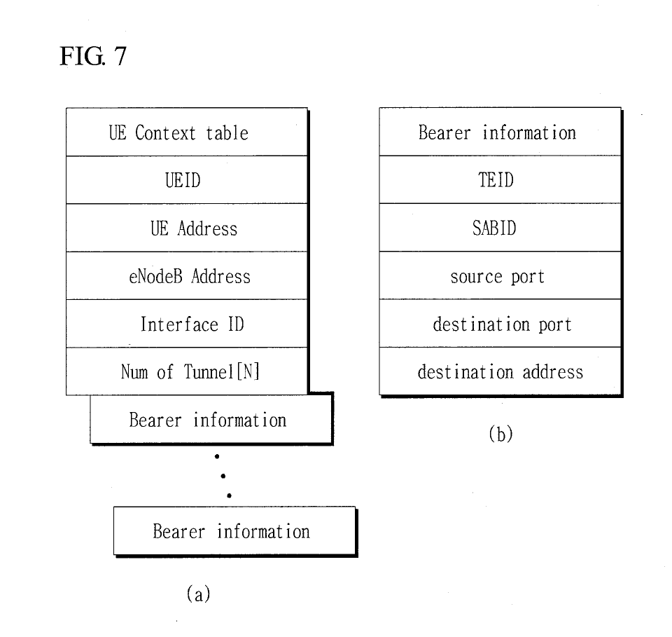

Referring to FIG. 7 showing the UE context table, UE context table (a) includes a UE address, an address of the eNodeB to which the UE belongs, an interface ID of the UE, and one or more bearer information (b) allocated to the UE, using the UE ID received from the MME 110 as a key. Bearer information (b) each includes a TEID of the bearer, an SAB ID for identifying an SAE bearer, and a port/IP address for a dedicated bearer.

Meanwhile, after the default bearer is set, the MME 110 completes the attachment process through the eNodeB 103 and the UE 100.

FIGS. 8, 9 and 10 are flowcharts of the UE context management module 113-3 in the S/PDN GW 113 in a bearer management procedure using a bearer management protocol according to an exemplary embodiment of the present invention. The UE context management module 113-3 is a functional module with a bearer management protocol in the S/PDN GW 113 according to an exemplary embodiment of the present invention and interfaces with the MME 110.

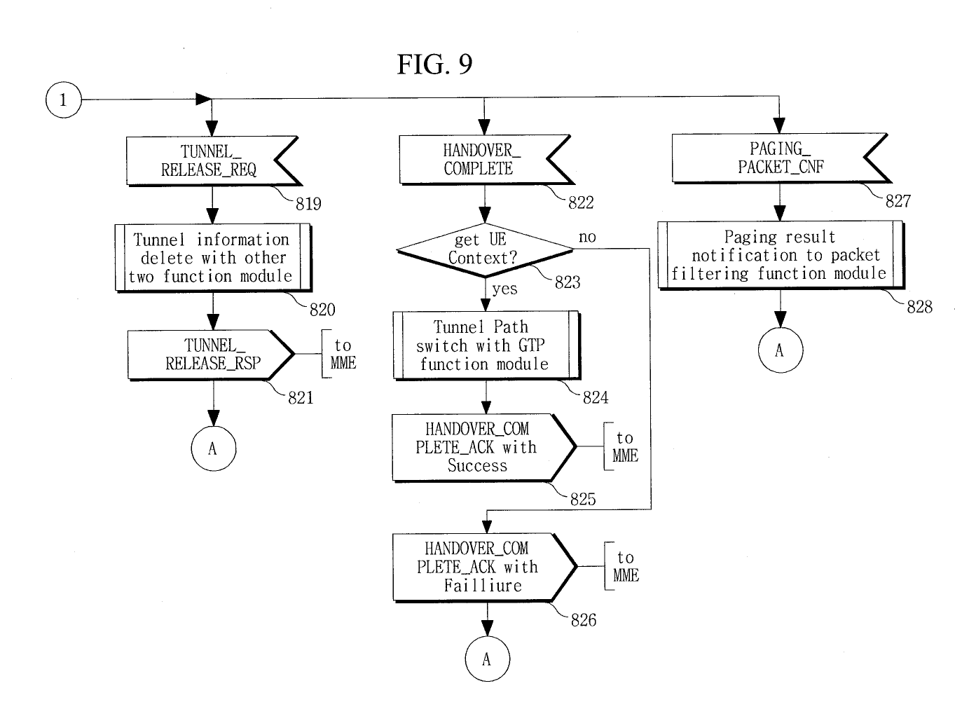

Referring to FIGS. 8 and 9, first, the UE context management module 113-3 initializes its table (operation 802). The UE context management module 113-3 then waits to receive messages from the MME 110 and the other function modules in the S/PDN GW 113 (operations 803 and 804). When a UE context setup request message SGW_CONTEXT_SETUP_REQ is received from the MME 110 (operation 805), the UE context management module 113-3 creates a UE context table of the S/PDN GW 113 using the received UE ID as a main key (operation 806), and allocates basic information such as a prefix, Netmask, and an interface ID for creating an IP address to be used by the UE (operation 807). The UE context management module 113-3 sends a UE context setup response message SGW_CONTEXT_SETUP_RSP including the allocated information to the MME 110 (operation 808). When a UE context release request message SGW_CONTEXT_RELEASE_REQ is received from the MME 110 (operation 809), the UE context management module 113-3 deletes a UE context table corresponding to the received UE ID (operation 810) and also an IP address pool related to the UE (operation 811). The UE context management module 113-3 then sends a UE context release response message SGW_CONTEXT_RELEASE_RSP including the result information to the MME 110 (operation 812).

Meanwhile, when a tunnel setup request message TUNNEL_SETUP_REQ is received from the MME 110 (operation 813), the UE context management module 113-3 checks if there is a UE context table for the received UE ID (operation 814). If there is a UE context table, the UE context management module 113-3 adds bearer information to the table (operation 816) and allocates a TEID through internal communication with the user packet tunnel management module 113-2 in the S/PDN GW 112 (operation 817), and then sends a tunnel setup response message TUNNEL_SETUP_RSP including the allocated TEID to the MME 110 (operation 818). If it is determined in operation 814 that there is no UE context table for the received UE ID, the UE context management module 113-3 creates a new UE context table (operation 814) and sequentially performs the above operations (operations 816 to 818).

Meanwhile, when a tunnel release request message TUNNEL_RELEASE_REQ is received from the MME 110 (operation 819), the UE context management module 113-3 releases the tunnel through internal communication with the user packet tunnel management module 113-2 in the S/PDN GW 113, which has allocated the tunnel, and deletes the packet filtering table of the tunnel through internal communication with the packet filtering module 113-1 (operation 820). The UE context management module 113-3 then sends a tunnel release response message TUNNEL_SETUP_RSP including the UE ID and the result information to the MME 110 (operation 821).

When a handover completion message HANDOVER_COMPLETE is received from the MME 110, the UE context management module 113-3 checks if there is a UE context table for the received UE ID (operation 823). If there is a UE context table, the UE context management module 113-3 changes eNodeB addresses of all tunnels allocated to the UE through communication with the user packet tunnel management module 113-2 for managing an eNodeB path allocated to the UE (operation 824), and then sends a handover completion acknowledgement message HANDOVER_COMPLETE_ACK including the UE ID and the result information (success) to the MME 110 (operation 825). If it is determined in operation 823 that there is no UE context table for the received UE ID, the UE context management module 113-3 sends a handover completion acknowledgement message HANDOVER_COMPLETE_ACK including the UE ID and the result information (fail) to the MME 110 (operation 826).

Meanwhile, when a paging response message PAGING_PACKET_CNF is received from the MME 110 (operation 827), the UE context management module 113-3 delivers the result to the packet filtering module 113-1 that has first created the paging indication message (operation 828).

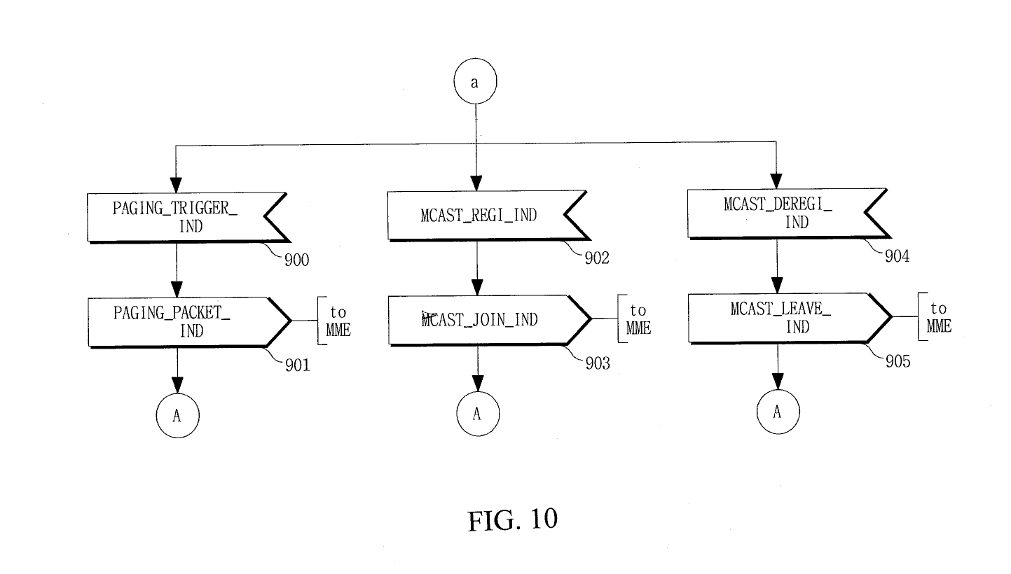

A process for when messages are received from other functional blocks rather than the MME 110 will now be described with reference to FIG. 10. Although the following is not directly related to the present invention, it is a basic process for creating the signal protocol between the MME 110 and the S/PDN GW 113 for bearer management of an exemplary embodiment of the present invention.

Referring to FIG. 10, first, when a paging trigger indication message PAGING_TRIGGER_IND along with a paging IP address is received from the packet filtering module 113-1 (operation 900), the packet filtering module 113-1 sends a paging indication message PAGING_PACKET_IND to the MME 110 (operation 901). When multicast-service join/leave messages are received from the packet filtering module 113-1 (operations 902 and 904), the packet filtering module 113-1 sends a multicast-service join message MCAST_JOIN_IND and a multicast-service leave message MCAST_LEAVE_IND including the received IP multicast address and the UE IP address to the MME 110 (operations 903 and 905).

As apparent from the above description, according to the exemplary embodiments of the present invention, an optimal signal protocol between the MME, which is an S11 interface of a 3G LTE standard reference model, and the S/PDN GW is designed to include default bearer setup, dedicated bearer setup, intra MME/inter eNodeB handoff, and paging signaling procedures for efficient bearer control and management in the IP-based evolved mobile communication network, resulting in satisfactory system performance requested by the 3G LTE.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

According to the present invention, a protocol is designed into the UE context and IP setup/release request, tunnel setup/release request, handover completion/completion acknowledgement, paging indication/response, and multicast-service join/leave indication messages according to a bearer control and management function between the MME and the gateway where a bearer exists, so that use of the messages and information elements thereof for control of various bearers can lead to high efficiency of signal protocol.

1. A method for controlling and managing a bearer in a gateway of an IP-based mobile communication network, comprising:
receiving a user equipment (UE) context setup request message including a UE ID;
creating a UE context table including bearer information using the UE ID as a key, and creating basic information required for creating an IP address to be used by the UE; and
sending a UE context setup response message including the basic information to a mobility management entity to set up UE context.

2. The method of claim 1, further comprising:
receiving a UE context release request message including the UE ID from the entity; and
deleting a context table and an IP address pool associated with the received UE ID, and sending a UE context release request response message including the result information to the entity to release the set UE context.

3. The method of claim 2, further comprising:
receiving a tunnel setup request message including the UE ID from the entity;
adding bearer information to a context table for the UE ID included in the tunnel setup request message and allocating a tunnel ID to create a tunnel ID table; and
sending a tunnel setup response message including the tunnel ID to the entity for tunnel setup.

4. The method of claim 3, wherein the tunnel setup request message comprises at least one of a tunnel service type, a correspondent NodeB address, an SAB ID, source and destination ports, a destination address, a multicast address, and a session ID.

5. The method of claim 3, further comprising:
receiving a tunnel release request message including the UE ID from the entity; and
releasing a tunnel associated with the received UE ID, deleting a packet filtering table of the tunnel, and sending a tunnel release response message including the result information to the entity.

6. The method of claim 3, further comprising:
receiving a handover completion message including the UE ID from the entity;
changing NodeB address information of all tunnels allocated to the received UE ID into NodeB address information included in the handover completion message; and
sending a handover completion acknowledgement message including the received UE ID and the result information to the entity.

7. The method of claim 3, further comprising: when a paging trigger indication message including the IP address is received, sending a paging indication message including a corresponding paging IP address to the entity and receiving a corresponding paging response message.

8. The method of claim 3, further comprising: when a multicast-service join or leave message including an IP multicast address and a UE IP address is received, sending the multicast-service join or leave message to the entity.

9. The method of claim 1, further comprising:
receiving a tunnel setup request message including the UE ID from the entity;
adding bearer information to a context table for the UE ID included in the tunnel setup request message and allocating a tunnel ID to create a tunnel ID table; and
sending a tunnel setup response message including the tunnel ID to the entity for tunnel setup.

10. The method of claim 9, wherein the tunnel setup request message comprises at least one of a tunnel service type, a correspondent NodeB address, an SAB ID, source and destination ports, a destination address, a multicast address, and a session ID.

11. The method of claim 9, further comprising:
receiving a tunnel release request message including the UE ID from the entity; and
releasing a tunnel associated with the received UE ID, deleting a packet filtering table of the tunnel, and sending a tunnel release response message including the result information to the entity.

12. The method of claim 9, further comprising:
receiving a handover completion message including the UE ID from the entity;
changing NodeB address information of all tunnels allocated to the received UE ID into NodeB address information included in the handover completion message; and
sending a handover completion acknowledgement message including the received UE ID and the result information to the entity.

13. The method of claim 9, further comprising: when a paging trigger indication message including the IP address is received, sending a paging indication message including a corresponding paging IP address to the entity and receiving a corresponding paging response message.

14. The method of claim 9, further comprising: when a multicast-service join or leave message including an IP multicast address and a UE IP address is received, sending the multicast-service join or leave message to the entity.

15. A method for controlling and managing a bearer in a mobility management entity that manages mobility of user equipment (UE) and provides an interface for UE authentication, comprising:
allocating a UE ID to UE authenticated by making a request for a connection to a network;
sending a UE context setup request message including the UE ID to a serving gateway;
receiving a UE context setup response message including information required for creating an IP address to be used by the UE;
sending a tunnel setup request message to the serving gateway; and
receiving a tunnel setup response message including a tunnel ID and setting a default bearer with the serving gateway.

16. The method of claim 15, wherein the tunnel setup request message comprises at least one of a UE ID, a tunnel service type, a correspondent NodeB address, an SAB ID, source and destination ports, a destination address, a multicast address, and a session ID.

17. The method of claim 15, further comprising: when the UE is powered off, sending a UE context release request message including the UE ID to the serving gateway, and receiving a UE context release request response message including the result information for connection releases.

18. The method of claim 17, further comprising: when the UE makes a request for service release, sending a tunnel release request message including the UE ID to the serving gateway, and receiving a tunnel release response message including the result information for service release.

19. The method of claim 18, further comprising: when a paging indication message including a paging IP address is received, sending a paging response message including the paging IP address and the result information to the gateway.

20. The method of claim 15, further comprising at least one of:
when a paging indication message including the paging IP address is received, sending a paging response message including the paging IP address and the result information to the gateway; and
when the UE makes a request for service release, sending a tunnel release request message including the UE ID to the serving gateway, and receiving a tunnel release response message including the result information for service release.
